(19) United States
(12) Patent Application Publication
(10) Pub. No.: US 2014/0189265 A1
(43) Pub. Date: Jul. 3, 2014

(54) ATOMIC TIME COUNTER SYNCHRONIZATION

(71) Applicant: ADVANCED MICRO DEVICES, INC., Sunnyvale, CA (US)

(72) Inventors: Paul Kitchin, Austin, TX (US); William Walker, Fort Collins, CO (US)

(73) Assignee: ADVANCED MICRO DEVICES, INC., Sunnyvale, CA (US)

(21) Appl. No.: 13/732,330

(22) Filed: Dec. 31, 2012

(51) Int. Cl. G06F 9/30

(52) U.S. Cl. CPC G06F 9/30087; G06F 9/3004
USPC 711/155

(57) ABSTRACT

Methods, integrated circuit devices, and fabrication processes relating to synchronization of master and local timestamp counters (TSCs) are described. One method includes sending, to a memory bus, in response to an event that desynchronizes a master and a local TSC, a bus-lock command to perform atomic reading from a first memory location and atomic writing to a second memory location; reading a master timestamp from the master TSC via the first memory location; writing a local timestamp to the local TSC via the second memory location, to synchronize the local TSC with the master TSC; and sending, to the memory bus, a bus-unlock command; wherein the master TSC is memory mapped to the first memory location and the local TSC is memory mapped to the second memory location.

### BACKGROUND

1. Technical Field

Generally, the disclosed embodiments relate to integrated circuits, and, more particularly, to timestamp counters used in integrated circuits.

2. Description of the Related Art

Integrated circuit devices, such as computer processors, may make use of timestamps to provide a time context to various elements of the integrated circuit and/or software being executed by one or more elements of the integrated circuit. Timestamps may be generated by timestamp counters (TSCs). TSCs generally supply software with a time context necessary for many software-based decisions. TSCs are also helpful in providing debug information when included with other debug state in the processor. For example, timestamps may allow a debugging operation to better understand possible causes of various operational errors of the processor.

Different parts of a processor system require access to TSCs. Among the elements requiring such access are one or more compute units, e.g., a CPU, a core of a multi-core CPU, a GPU, a core of a multi-core GPU, an APU, a core of a multi-core APU, etc. To reduce the latency of accesses by a compute unit to a TSC, it may be desirable for each compute unit to have a local TSC, which may be accessed with lower latency than a system-wide, or master TSC.

The presence of multiple TSCs, i.e., a master TSC and at least one local TSC, in a computer system could create a potential problem for system operations. Generally, at any given time, multiple processes are running in a system. Each process may receive timestamps from one or more TSCs, and generally, the entire population of processes will receive timestamps from substantially all of the TSCs in the system. Because desynchronization of the timestamps seen by one or more processes may lead to faulty operation of a process or processes, it is desirable to keep all TSCs synchronized across the system, so that each consumer of a TSC reads a similar timestamp from the TSC at any given time.

Desynchronization of timestamps may arise from the inherent complexity of operations of modern computer systems. Also, certain events can corrupt a local TSC, such as a power event, e.g., clock frequency changes or powering down of a compute unit or a core thereof

Other workers have attempted to prevent desynchronization of, and/or synchronize, master and local TSCs by making use of dedicated hardware between each instantiation of the TSC that forces synchronization between the master and local TSCs. This provides a high level of confidence that the TSCs are synchronized, but requires additional hardware to be designed, fabricated, and operated.

Another possible approach can be attempted if the TSCs are accessible via the memory bus hierarchy, i.e., are in a memory mapped configuration access. Local hardware can then use the existing memory bus hierarchy to read the master TSC copy and write it to the local TSC copy. This avoids the need for additional hardware, but provides little confidence that a good synchronization occurred. Confidence is low because the bus hierarchy can have other traffic that delays the synchronization process. For example, between the master TSC read and the local TSC write, if other bus requests occur that delay the local TSC write, then when the local TSC write finally occurs, the master TSC could have increased substantially and indeterministically.

### SUMMARY OF EMBODIMENTS

The apparatuses, systems, and methods in accordance with the embodiments disclosed herein may facilitate synchronization of master and local timestamp counters in a computer system, thereby facilitating the execution by the computer system of software making use of master and local timestamps, and/or debugging operations by the computer system making use of logs timed by master and local timestamps. Mechanisms controlling and implementing such a process may be formed within a microcircuit by any means, such as by growing or deposition.

Some embodiments provide an integrated circuit device that includes a master timestamp counter (TSC) configured to provide a master timestamp; a compute unit comprising a local TSC, wherein the local TSC is configured to provide a local timestamp; a memory, comprising a first memory location to which the master TSC is memory mapped, a second memory location to which the local TSC is memory mapped, and a memory bus configured to allow atomic reading from at least the first memory location and atomic writing to at least the second memory location in response to receiving a bus-lock command; wherein the compute unit is configured to issue the bus-lock command to the memory bus, in response to an event that desynchronizes the master TSC and the local TSC; read the master timestamp from the master TSC via the first memory location; write the local timestamp to the local TSC via the second memory location, to synchronize the local TSC with the master TSC; and issue a bus-unlock command to the memory bus.

Some embodiments provide a method that includes sending, to a memory bus, in response to an event that desynchronizes a master TSC and a local TSC, a bus-lock command to perform atomic reading from a first memory location and atomic writing to a second memory location; reading a master timestamp from the master TSC via the first memory location; writing a local timestamp to the local TSC via the second memory location, to synchronize the local TSC with the master TSC; and sending, to the memory bus, a bus-unlock command, wherein the master TSC is memory mapped to the first memory location and the local TSC is memory mapped to the second memory location.

The embodiments described herein may be used in any type of integrated circuit that comprises a master TSC and a compute unit comprising a local TSC. One example is a general purpose microprocessor.

### BRIEF DESCRIPTION OF THE FIGURES

The disclosed subject matter will hereafter be described with reference to the accompanying drawings, wherein like reference numerals denote like elements, and:

FIG. 1 is a schematic diagram of an exemplary microcircuit design in accordance with some embodiments.

FIG. 2 is a schematic diagram of a central processing unit depicted in FIG. 1, in accordance with some embodiments.

FIG. 3A provides a representation of a silicon die/chip that includes one or more circuits as shown in FIG. 2, in accordance with some embodiments.

FIG. 3B provides a representation of a silicon wafer which includes one or more dies/chips that may be produced in a fabrication facility, in accordance with some embodiments.

FIG. 4 is a flowchart of a method relating to synchronizing a master timestamp counter and a local timestamp counter, in accordance with some embodiments.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Embodiments provide for synchronizing a master timestamp counter and a local timestamp counter in a computer system. Such synchronization may improve the execution of software by the computer system and/or facilitate debugging of operations of the computer system.

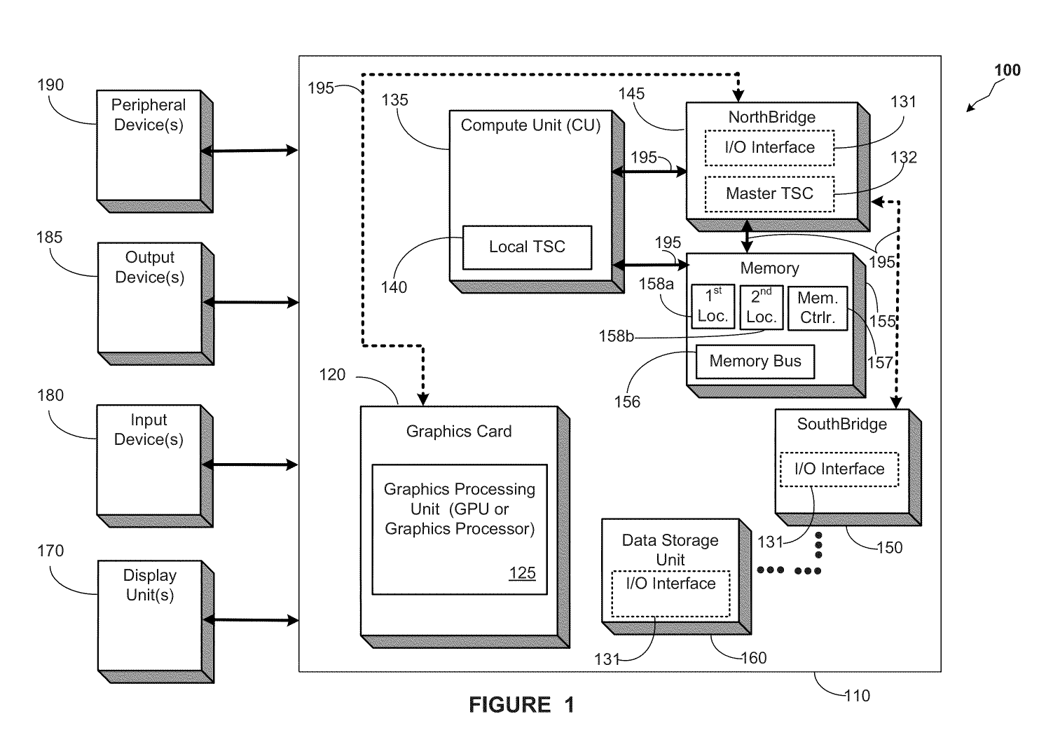

Turning now to FIG. 1, a block diagram representation of a computer system 100 comprising a processor 110, in accordance with some embodiments, is illustrated. Modern computer systems may exist in a variety of forms, such as telephones, tablet computers, desktop computers, laptop computers, servers, smart televisions, or other consumer or commercial electronic devices. The processor unit 110 may comprise one or more compute units (CUs) 135. Each compute unit 135 may comprise a local timestamp counter (TSC) 140 that provides a timestamp accessible by other elements (not shown) of compute unit 135 with low latency. One or more compute unit(s) 135 may be configured to send bus-lock and bus-unlock commands to a memory bus 156, as will be discussed in more detail below.

The computer system 100 may also comprise a northbridge 145. Among its various components, the northbridge 145 may comprise a master TSC 132 that may provide a master timestamp to other elements of the computer system 100.

The computer system 100 may also comprise a memory 155 (e.g., a DRAM). The memory 155 may comprise a plurality of memory locations, such as a first memory location 158a and a second memory location 158b. The memory 155 may comprise memory controller 157 a memory bus 156 for receiving read and write requests from computer unit 135, northbridge 145, and/or other elements of the processor 110 and/or computer system 100. The memory controller 157 may control various operations of the memory 155.

In some embodiments, the master TSC 132 and the local TSC 140 may be memory mapped. In other words, the compute unit 135 may “see” master TSC 132 as being located at first memory location 158a and local TSC 140 as being located at second memory location 158b. Memory mapping may be affected by memory bus 156. The compute unit 135 may then read from and write to master TSC 132 by reading from and writing to first memory location 158a, and read from and write to local TSC 140 by reading from and writing to second memory location 158b. Memory bus 156 may periodically, and/or in response to a read or write request, ensure the contents of the first memory location 158a match the contents of master TSC 132, and likewise for second memory location 158b and local TSC 140.

Memory bus 156 may also be configured to receive bus-lock and bus-unlock commands. Such commands may be issued or sent by a compute unit 135 or another element of the computer system 100, e.g., a GPU 125 or a southbridge 150, among others. Such commands may refer to one or more memory locations within memory 155, such as first memory location 158a and/or second memory location 158b. A bus-lock command instructs the memory bus 156 to perform atomic reading and writing of the referred memory location(s). “Atomic” is used herein to mean that a series of operations, e.g., reading and writing of the referred memory location(s), is performed such that all the operations are performed in series without any intervening operations.

Upon receipt of a bus-lock command, memory bus 156 may allow existing requests by compute unit 135 and/or referencing location(s) within memory 155, such as first memory location 158a and/or second memory location 158b, to be completed before permitting the atomic reading and writing. In some embodiments, memory bus 156 will allow existing requests to be completed before permitting the atomic reading and writing. In some embodiments, memory bus 156 may terminate existing requests before permitting the atomic reading and writing.

Bus-locking may thus allow, without interruption from other operations, the compute unit 135 to read the master timestamp from master TSC 132 via the memory map of master TSC 132 to first memory location 158a, followed by writing a local timestamp to local TSC 140 via the memory map of local TSC 140 to second memory location 158b. The local timestamp written to local TSC 140 may be the same as the master timestamp read from master TSC 132, or it may differ from the master timestamp by a known, unchanging number of system clock cycles and/or length of time. If either of the foregoing conditions obtain, the local TSC 132 may be considered synchronized with the master TSC 140.

Upon receipt of a bus-unlock command, memory bus 156 may cease to perform atomic reading and writing of the referred memory locations, e.g., first memory location 158a and/or second memory location 158b. The compute unit 135 may issue a bus-unlock command at any time after writing the local timestamp to local TSC 140. In some embodiments, the compute unit 135 may verify the master TSC and the local TSC are synchronized before issuing the bus-unlock command.

The computer system 100 may as a routine matter comprise other known units and/or components, e.g., one or more I/O interfaces 131, a southbridge 150, a data storage unit 160, display unit(s) 170, input device(s) 180, output device(s) 185, and/or peripheral devices 190, among others.

The computer system 100 may also comprise one or more data channels 195 for communication between one or more of the components described above.

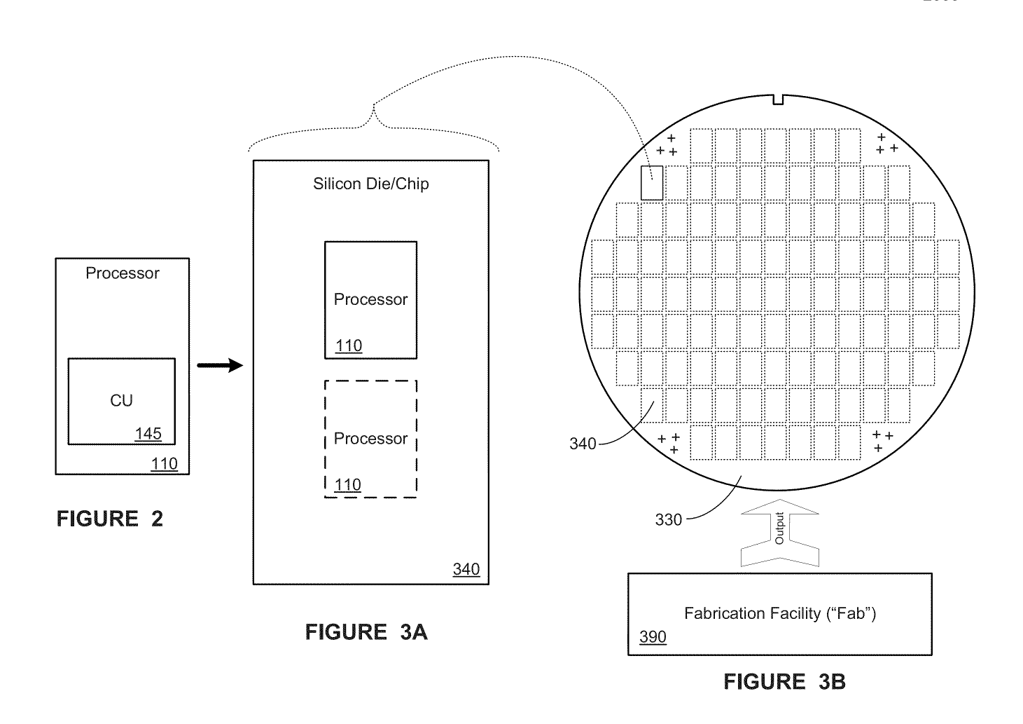

Turning now to FIG. 2 and FIG. 3A, in some embodiments, the processor unit 110 may reside on a silicon die/chip 340. The silicon die/chip 340 may be housed on a motherboard or other structure of the computer system 100. In some embodiments, there may be more than one processor unit 110 on each silicon die/chip 340. Some embodiments of the processor unit 110 may be used in a wide variety of electronic devices.

Turning now to FIG. 3B, in accordance with some embodiments, and as described above, the processor unit 110 may be included on the silicon chip/die 340. The silicon chip/die 340 may contain one or more different configurations of the processor unit 110. The silicon chip/die 340 may be produced on a silicon wafer 330 in a fabrication facility (or “fab”) 390. That is, the silicon wafer 330 and the silicon die/chip 340 may be referred to as the output, or product of, the fab 390. The silicon chip/die 340 may be used in electronic devices.

The circuits described herein may be formed on a semiconductor material by any known means in the art. Forming can be done, for example, by growing or deposition, or by any other means known in the art. Different kinds of hardware descriptive languages (HDL) may be used in the process of designing and manufacturing the microcircuit devices. Examples include VHDL and Verilog/Verilog-XL. In some embodiments, the HDL code (e.g., register transfer level (RTL) code/data) may be used to generate GDS data, GDSII data and the like. GDSII data, for example, is a descriptive file format and may be used in some embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, compact discs, DVDs, solid state storage and the like) and, in some embodiments, may be used to configure a manufacturing facility (e.g., through the use of mask works) to create devices capable of embodying various aspects of some embodiments. As understood by one or ordinary skill in the art, this data may be programmed into a computer, processor, or controller, which may then control, in whole or part, the operation of a semiconductor manufacturing facility (or fab) to create semiconductor products and devices. In other words, some embodiments relate to a non-transitory computer-readable medium storing instructions executable by at least one processor to fabricate an integrated circuit. These tools may be used to construct the embodiments described herein.

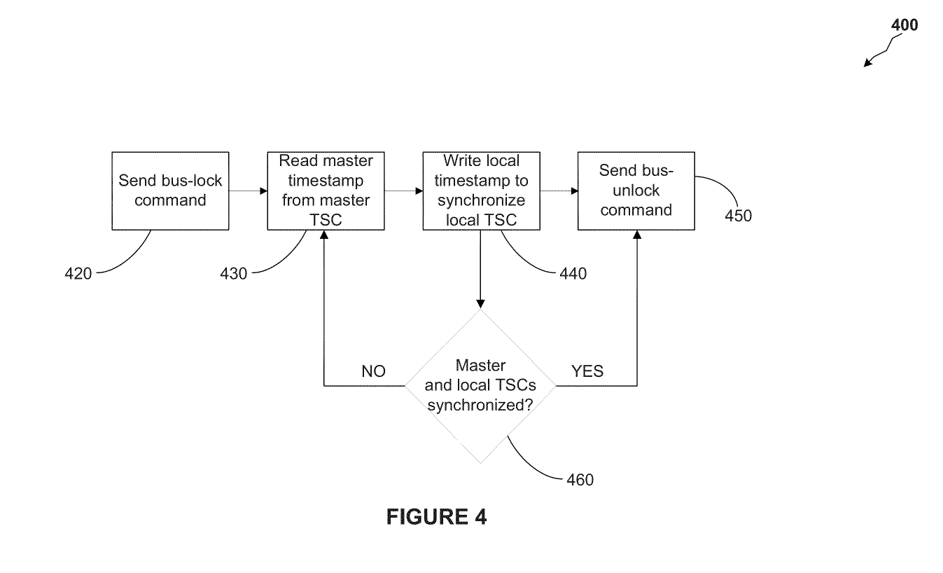

FIG. 4 presents a flowchart depicting a method 400 according to some embodiments. As illustrated in FIG. 4, the method 400 may comprise sending at 420, to a memory bus, in response to an event that desynchronizes a master timestamp counter (TSC) and a local TSC, a bus-lock command to perform atomic reading from a first memory location and atomic writing to a second memory location. In some embodiments, the event may be at least one of a change in clock frequency of a compute unit comprising the local TSC or a powering up of the compute unit comprising the local TSC. As discussed above, the master TSC may be memory mapped to the first memory location and the local TSC may be memory mapped to the second memory location.

The method 400 may also comprise reading at 430 a master timestamp from the master TSC via the first memory location and writing at 440 a local timestamp to the local TSC via the second memory location. The reading at 430 and the writing at 440 may synchronize the local TSC with the master TSC.

In some embodiments, the reading at 430 and the writing at 440 may be considered sufficient to synchronize the local TSC and the master TSC. In other embodiments, the method 400 may further comprise verifying at 460 the master TSC and the local TSC are synchronized prior to the sending the bus-unlock command. If their synchronization is verified at 460, the bus-unlock command may be sent at 450 to the memory bus. If the master TSC and the local TSC are not synchronized, flow may return to reading at 430, with rereading the master timestamp from the master TSC via the first memory location; rewriting the local timestamp to the local TSC via the second memory location, to synchronize the local TSC with the master TSC; and reverifying the master TSC and the local TSC are synchronized prior to the sending the bus-unlock command.

The methods illustrated in FIG. 4 may be governed by instructions that are stored in a non-transitory computer readable storage medium and that are executed by at least one processor of the computer system 100. Each of the operations shown in FIG. 4 may correspond to instructions stored in a non-transitory computer memory or computer readable storage medium. In various embodiments, the non-transitory computer readable storage medium includes a magnetic or optical disk storage device, solid state storage devices such as flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
sending to a memory bus, in response to an event that desynchronizes a master timestamp counter (TSC) and a local TSC, a bus-lock command to perform atomic reading from a first memory location and atomic writing to a second memory location;
reading a master timestamp from the master TSC via the first memory location;
writing a local timestamp to the local TSC via the second memory location, to synchronize the local TSC with the master TSC; and
sending, to the memory bus, a bus-unlock command;
wherein the master TSC is memory mapped to the first memory location and the local TSC is memory mapped to the second memory location.

2. The method of claim 1, wherein the event is at least one of a change in clock frequency of a compute unit comprising the local TSC or a powering up of the compute unit comprising the local TSC.

3. The method of claim 1, further comprising:
verifying the master TSC and the local TSC are synchronized prior to the sending the bus-unlock command.

4. The method of claim 3, further comprising, in response to a finding the master TSC and the local TSC are not synchronized:
rereading the master timestamp from the master TSC via the first memory location;
rewriting the local timestamp to the local TSC via the second memory location, to synchronize the local TSC with the master TSC; and
reverifying the master TSC and the local TSC are synchronized prior to the sending the bus-unlock command.

5. An integrated circuit device, comprising:
a master timestamp counter (TSC) configured to provide a master timestamp;
a compute unit comprising a local TSC, wherein the local TSC is configured to provide a local timestamp;
a memory, comprising a first memory location to which the master TSC is memory mapped, a second memory location to which the local TSC is memory mapped, and a memory bus configured to allow atomic reading from the first memory location and atomic writing to the second memory location in response to receiving a bus-lock command;
wherein the compute unit is configured to issue the bus-lock command to the memory bus in response to the master TSC and the local TSC desynchronizing; read the master timestamp from the master TSC via the first memory location; write the local timestamp to the local TSC via the second memory location, to synchronize the local TSC with the master TSC; and issue a bus-unlock command to the memory bus.

6. The integrated circuit device of claim 5, wherein the compute unit is configured to detect at least one of a change in clock frequency of the compute unit or a powering up of the compute unit.

7. The integrated circuit device of claim 5, wherein the compute unit is further configured to verify the master TSC and the local TSC are synchronized, and the compute unit is configured to issue the bus-unlock command in response to the verifying.

8. The integrated circuit device of claim 7, wherein the compute unit is further configured, in response to a finding the master TSC and the local TSC are not synchronized, to reread the master timestamp from the master TSC via the first memory location; rewrite the local timestamp to the local TSC via the second memory location, to synchronize the local TSC with the master TSC; and reverify the master TSC and the local TSC are synchronized, and the compute unit is configured to issue the bus-unlock command in response to the reverifying.

9. A non-transitory computer-readable medium storing instructions executable by at least one processor to fabricate an integrated circuit, the integrated circuit comprising:
a master timestamp counter (TSC) configured to provide a master timestamp;
a compute unit comprising a local TSC, wherein the local TSC is configured to provide a local timestamp;
a memory, comprising a first memory location to which the master TSC is memory mapped, a second memory location to which the local TSC is memory mapped, and a memory bus configured to allow bus-lock command to perform atomic reading from the first memory location and atomic writing to the second memory location in response to receiving a bus-lock command;
wherein the compute unit is configured to issue the bus-lock command to the memory bus in response to the master TSC and the local TSC desynchronizing; read the master timestamp from the master TSC via the first memory location; write the local timestamp to the local TSC via the second memory location, to synchronize the local TSC with the master TSC; and issue a bus-unlock command to the memory bus.

10. The non-transitory computer readable storage medium of claim 9, wherein the compute unit is configured to detect at least one of a change in clock frequency of the compute unit or a powering up of the compute unit.

11. The non-transitory computer readable storage medium of claim 9, wherein the compute unit is further configured to verify the master TSC and the local TSC are synchronized, and the compute unit is configured to issue the bus-unlock command in response to the verifying.

12. The non-transitory computer readable storage medium of claim 11, wherein the compute unit is further configured, in response to a finding the master TSC and the local TSC are not synchronized, to reread the master timestamp from the master TSC via the first memory location; rewrite the local timestamp to the local TSC via the second memory location, to synchronize the local TSC with the master TSC; and reverify the master TSC and the local TSC are synchronized, and the compute unit is configured to issue the bus-unlock command in response to the reverifying.
